(19) United States
(12) Patent Application Publication
(10) Pub. No.: US 2005/0174430 A1
(43) Pub. Date: Aug. 11, 2005

(54) Method for organizing photographic images in a computer for locating, viewing and purchase

(76) Inventor: Michael E. Anderson, Laguna Beach, CA (US)

Correspondence Address: MORLAND C FISCHER, 2030 MAIN ST, SUITE 1050, IRVINE, CA, 92614, US

(21) Appl. No.: 10/775,603

(22) Filed: Feb. 9, 2004

(51) Int. Cl. H04N 5/225

(52) U.S. Cl. 348/207.1

(57) ABSTRACT

A method by which photographic images taken by a photographer using a digital camera having mass storage capability are efficiently organized within a computer so as to be quickly and easily located, viewed and purchased by customers of the photographer. The photographic images taken by the camera are copied into high resolution and low resolution images. The high resolution images are transferred to a high resolution storage. The low resolution images are downloaded to the computer to be located within a folder structure according to markers assigned by the photographer to distinguish different sets of images by subject. An image display is provided to enable customers of the photographer to access, view and purchase images by completing an order form via a remote or a home computer. An order viewer is provided to enable the photographer to review, edit and fill the order of a customer by transmitting the high resolution images from the high resolution storage to a photo lab for processing.

### BACKGROUND OF THE INVENTION

1. Field of the Invention

This invention relates to a method by which photographic images taken by a photographer using a digital camera having mass storage capability can be downloaded to a computer wherein the images are efficiently organized so as to be quickly and easily located, viewed and purchased by customers of the photographer.

2. Background Art

It is known for the public to be able to view and acquire photographic images that are offered for sale over the Internet. However, many photographers are reluctant to offer web sales of their work because of the lack of security and control associated with the sales process. That is to say, in many instances, consumers who have accessed the images owned by a photographer on-line have downloaded and printed the images without paying the photographer for his work. In this case, there are few safeguards to prevent the unauthorized acquisition and use of the photographer's web based images by the public without first obtaining the permission of and/or offering compensation to the photographer.

In other cases, customers of the photographer are typically required to review large numbers of photographic images before finally being able to locate the particular image or images of their choice to be purchased. Because there is no reliable way known to efficiently organize the photographic images to enable quick and easy viewing and ordering by customers, considerable time may be wasted at the photographer's website inasmuch as the customer must click through one image or location after another before finally being able to locate the pictures of choice. Having to waste time reviewing the images taken by the photographer for different ones of his or her customers has been known to lead to customer confusion and a decline in (web) sales.

### SUMMARY OF THE INVENTION

In general terms, a method is disclosed herein by which a photographer using a digital camera can take a variety of photographic images of different subjects and then make the images available for viewing and purchase by customers of the photographer. In a preferred embodiment, the digital camera to be used herein is of the type having a removable mass media storage device in which digital images can be stored. In this case, when the photo session has been completed, the storage device is removed from the camera and the images stored therein are downloaded to a computer by means of a card reader, or the like. The storage device can then be erased and returned to the camera for reuse.

It is important to this invention for the photographer to be able to annotate or mark the photographic images to distinguish one set of images from the next. Such annotations or markers may be established as a sound file that is created by the photographer speaking directly into the mass media storage device of the camera or as a locked image file or as a flat image (e.g., a single color) file. The marked file that is chosen by the photographer will enable him or her to label each set of images to be downloaded to the computer and located within a particular image folder of a folder structure that is made available to customers at a server folder on a remote (e.g., the photographer's) computer or a web based home computer of the customer. The photographer is also able to enter into the folder structure prior to download subject or event designations by which to enable customers of the photographer to quickly and easily locate, view and order images that are located at respective image folders of the folder structure. That is to say, the information within the folder structure is converted to click-on buttons to be selectively activated by the customer in order to view particular images of interest from the different sets of images that have been shot by the photographer and located in respective ones of the image folders.

Location controls are provided to automatically prompt the photographer for subject information corresponding to the marker files by which to help identify and locate the photographic images. The location controls is responsible for moving high resolution images stored in the mass media storage device to a high resolution storage folder for processing (e.g., at a photo lab) after a customer's order has first been received and finalized. The location control is also responsible for making and moving identical low resolution images into image folders of the folder structure for eventual viewing by customers.

An image display is initiated to play for a customer a slide show of photographic images that are located in and selected from the folder structure. The foregoing is accomplished by the customer actuating click-on buttons that are made available to him or her. The image display provides an order form that enables the customer to order images of his or her choice by entering appropriate information so that the order can be filled by the photographer. A timing function is provided to limit the time afforded the customer to choose an image and complete the order form before the image display is reset to accommodate a new customer.

An order viewer is provided by which to enable the photographer to fill an order that has been finalized by the customer. The order viewer enables the customer's order to be displayed, reviewed and updated by the photographer. The order viewer tracks and displays the progress of and payment for each order so as to enable the photographer to print out a hard copy, to send an e-mail payment reminder to the customer, and to create an order folder from the high resolution storage folder so that the high resolution images originally stored therein may now be sent to a photo laboratory for processing an order for which payment has been received.

### BRIEF DESCRIPTION OF THE DRAWINGS

FIG. 1 is a block diagram representing the preferred method for organizing digital photographic images taken by a photographer and downloaded to a folder structure within a computer at which to facilitate locating, viewing and ordering images selected by customers of the photographer;

FIGS. 2A-2C show a flow diagram to illustrate the photographic image organization technique initiated by image controls of FIG. 1;

FIGS. 3A-3D show a flow diagram to illustrate the steps by which customers of the photographer locate, view and order photographic images according to an image display of FIG. 1; and

FIGS. 4A-4C show a flow diagram to illustrate the steps by which the photographer views, updates and processes the orders of his customers according to an order viewer of FIG. 1.

### DETAILED DESCRIPTION

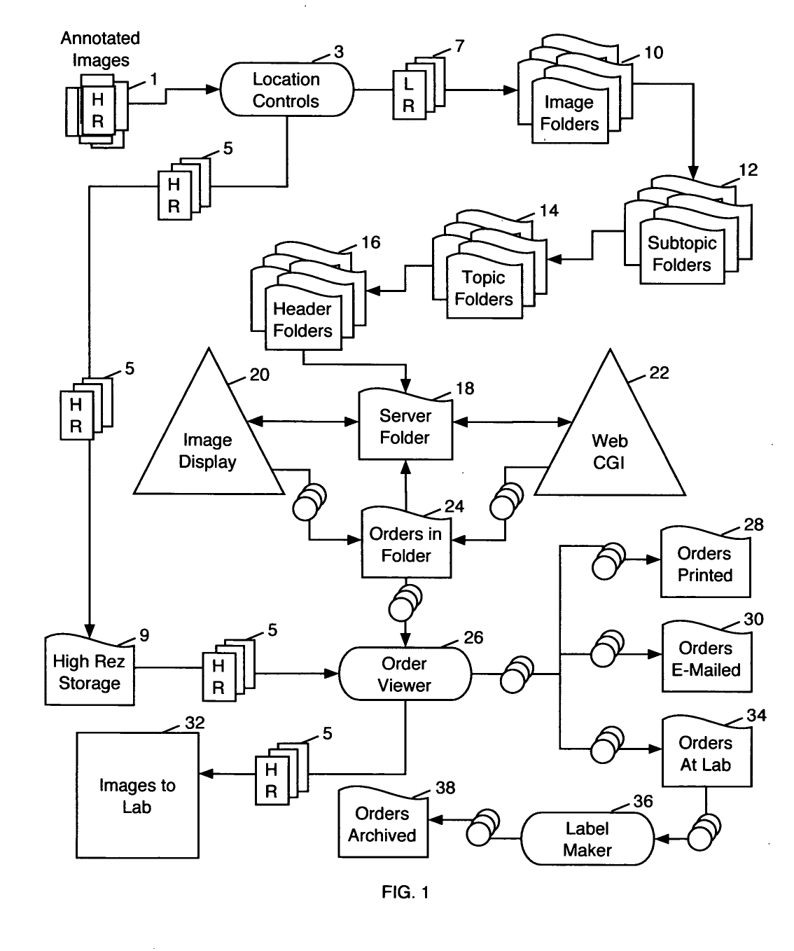

Referring initially to FIG. 1 of the drawings, there is shown a block diagram to illustrate the preferred method for efficiently organizing photographic (i.e., digital) images in a computer so that customers of a photographer can locate, view and order selected images at home or from a remote computer. The method herein disclosed requires that the photographer who will display his pictures use a digital camera 1 of the kind that is capable of taking photographic images and that has a removable mass media storage device in which to store image and sound data. In this same regard, the photographer must be able to annotate the photographic images so that marker files can be created by which to designate the end of a subject, session or event. The photographic images may be annotated and marked by means of a sound file spoken by the photographer into the mass media storage device of the camera 1 or a conventional locked image file or a flat image file (i.e., a random image of the sky, grass, a wall or the like, that is characterized by mostly a single color). For purposes of example only, a sound file will be described below for permitting the photographer to annotate the photographic images by his own spoken words. One commercially available camera for use herein that has a removable mass media storage capability which is sound (i.e., voice) sensitive is the Canon EOS1D digital camera.

In practice, the photographer can photograph a variety of different subjects or events. However, photographs of different subjects and events will be separated from one another by means of their respective annotations which, in this case, will be the photographer's sound marker files that are spoken into the camera 1 and stored in the mass media storage device thereof. In the case where the same subject or event is photographed at a later time, the photographer can use the same annotation as that previously selected.

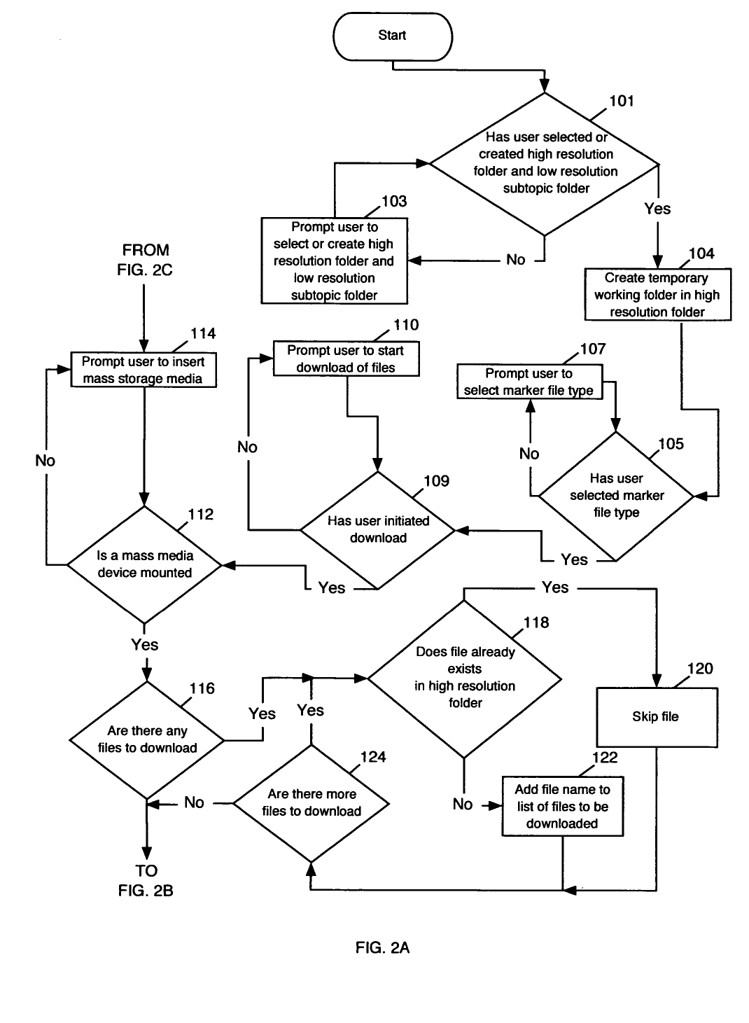

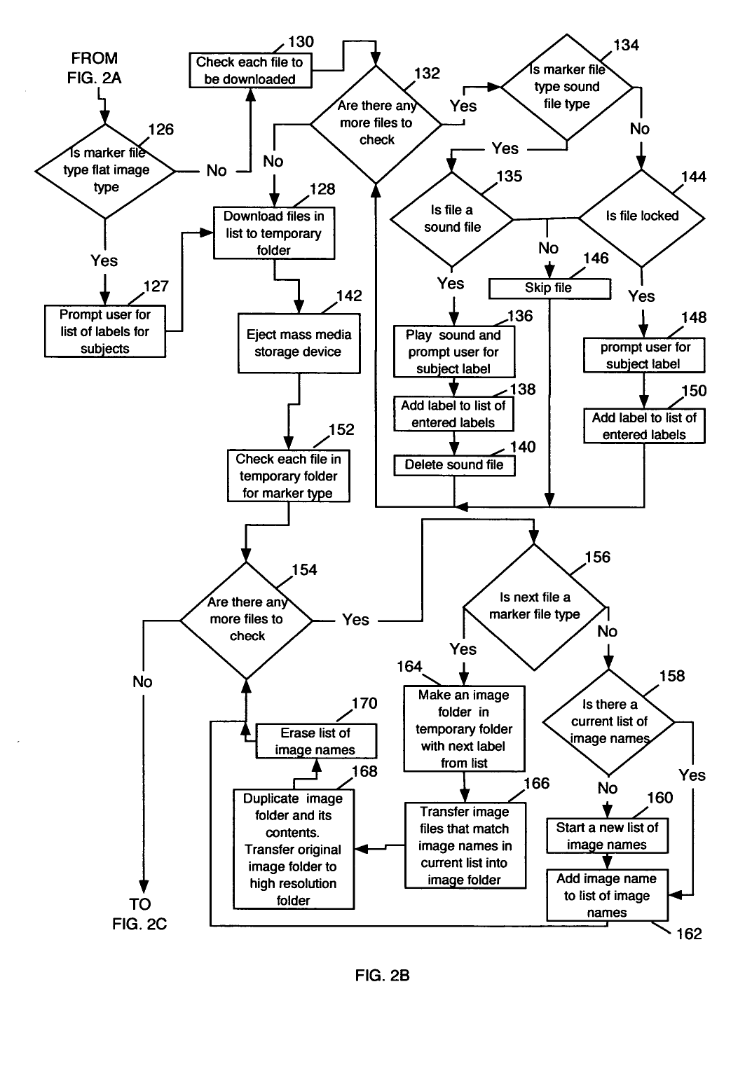

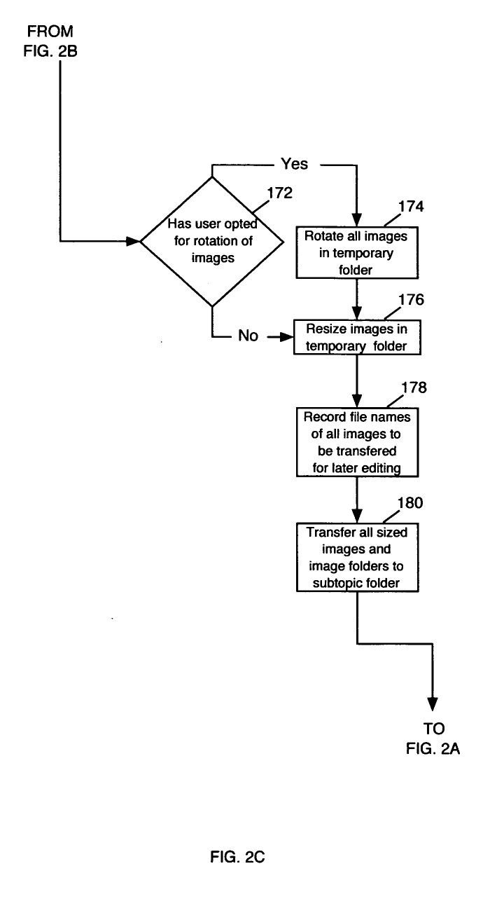

When he or she is ready, the photographer initiates a download to a computer of the photographic images and the corresponding marker files that have been stored in the removable mass media storage device of digital camera 1. By way of example, a suitable removable mass media storage device for use herein is a 512 mb compact flash memory card manufactured by Lexar. A card reader (not shown) such as that also manufactured by Lexar enables the images and sound data from the storage device to be downloaded to the computer and locating in particular image files by means of location controls 3. Details of the location controls 3 for enabling the computer to efficiently organize the photographic images for viewing and purchase by customers will be explained hereinafter when referring to FIGS. 2A-2C.

Briefly, however, the location controls 3 is responsible for establishing a folder structure for the photographer according to the subject and event represented by his photographic images. In this regard, it is to be understood that the names assigned to the folder structure and illustrated in FIG. 1 are for the purposes of illustration only and are not intended to limit the scope of this invention. Prior to downloading any image or sound data to the computer, the photographer initially sets up a topic folder 14 and a header folder 16 from options that are made available to him or her by the image controls 3.

File names that have been automatically designated by the camera 1 and the marker files chosen by the photographer are compared by the location controls 3 to uploaded file names of the current event or subject so that duplicate files (if any) can be eliminated or ignored. In the case where sound marker files are used, the first sound file is played back to the photographer from the storage device. In response to a prompt initiated by the location controls 3, the photographer types a corresponding label by referencing the sound which is just heard. In those cases where a locked image marker file or a flat image marker file is otherwise selected, the photographer is prompted by the location controls 3 to enter a label (usually obtained from handwritten notes that have been compiled by the photographer). The label entered by the photographer can be represented in any form or text to designate the corresponding subject or event (e.g., a name or number).

Once the first label has been entered, the location controls 3 automatically prompts the photographer for the next label in the event that additional subjects or events have been photographed. In the case where a sound maker file is selected, the photographer will hear the next of the series of sound files from the storage device. The location controls 3 will then prompt the photographer for the corresponding label. When the last file marker that is stored in the storage device has been given an appropriate label, the location controls 3 moves the high resolution (HR) images 5 from the digital camera 1 to a high resolution storage folder 9 for further processing (e.g., at a photo lab 32). The high resolution storage folder 9 has a temporary working folder wherein the high resolution images are copied and downsized to produce low resolution (LR) images 7. The low resolution (LR) images 7 have a smaller file size and are easier to manipulate than the high resolution (HR) images 5.

The image controls 3 uses the low resolution (LR) images 7 to create image folders 10 and subtopic folders 12. The image folders 10 will contain all of the photographic images that have been taken by the photographer and downloaded from the mass media storage device to the computer. The photographic images are located by the image controls 3 in respective image folders depending upon the labels that are entered by the photographer and correspond to the marker files selected by the photographer to distinguish different subjects or events. The contents of the image folder 10 are transferred by the image controls 3 to be merged with the subtopic folders 12. The contents of the image folders 10 and the subtopic folders 12 created by the image controls 3 and the topic folders 12 and header folders 16 are successively merged with one another to be transferred to a server folder 18 which resides on any computer (including that of the photographer) so that the images located within the image folders 10 can be viewed and ordered by customers at a remote location or at home over the Internet.

By way of example only, the photographer may use his digital camera 1 to capture different children playing the game of baseball. As indicated above, the header folders 16 and the topic folders 14 are created by the photographer. The photographer may annotate each of the images for a particular child with a sound file such as by speaking the child's name or player number into the camera having the mass media storage device. These same annotations are played back to the photographer to be used as the labels for identifying and distinguishing one set of images from another. The photographer's input to the header folders 16 can be the month or year during which the images were taken to enable customers to place an order now and/or in the future by viewing all of the images taken at a certain time. The photographer's input to the topic folders 14 can be a designation that is indicative of portraiture so as to distinguish these images from seascapes, landscapes, etc.

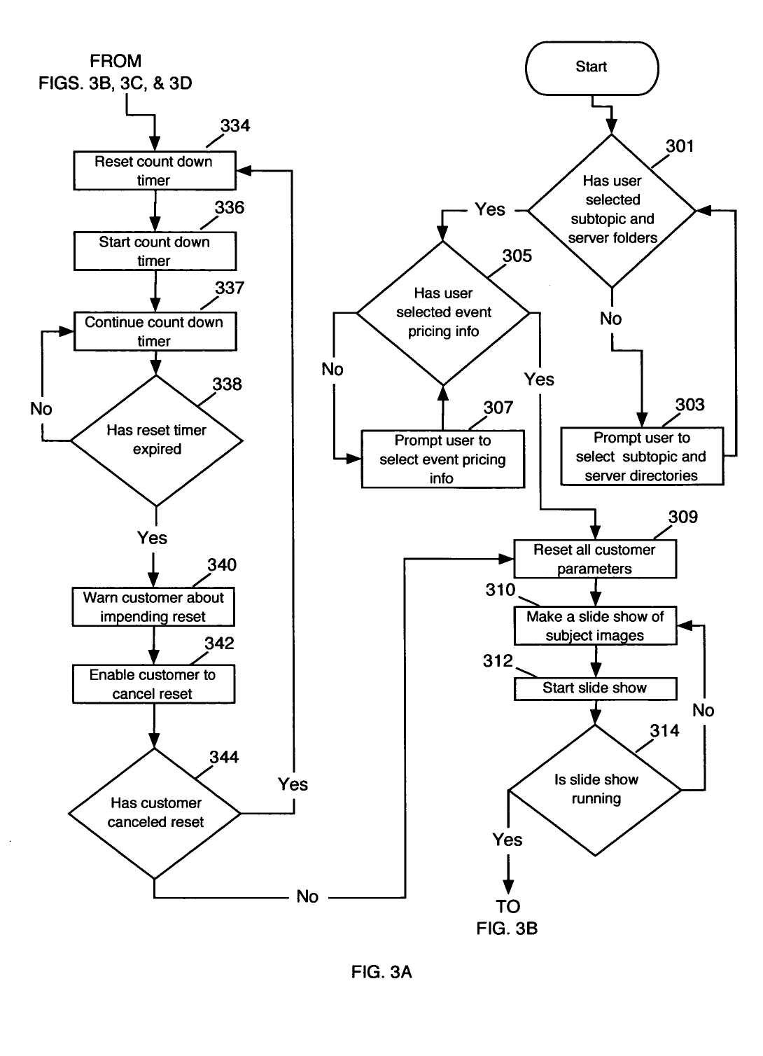

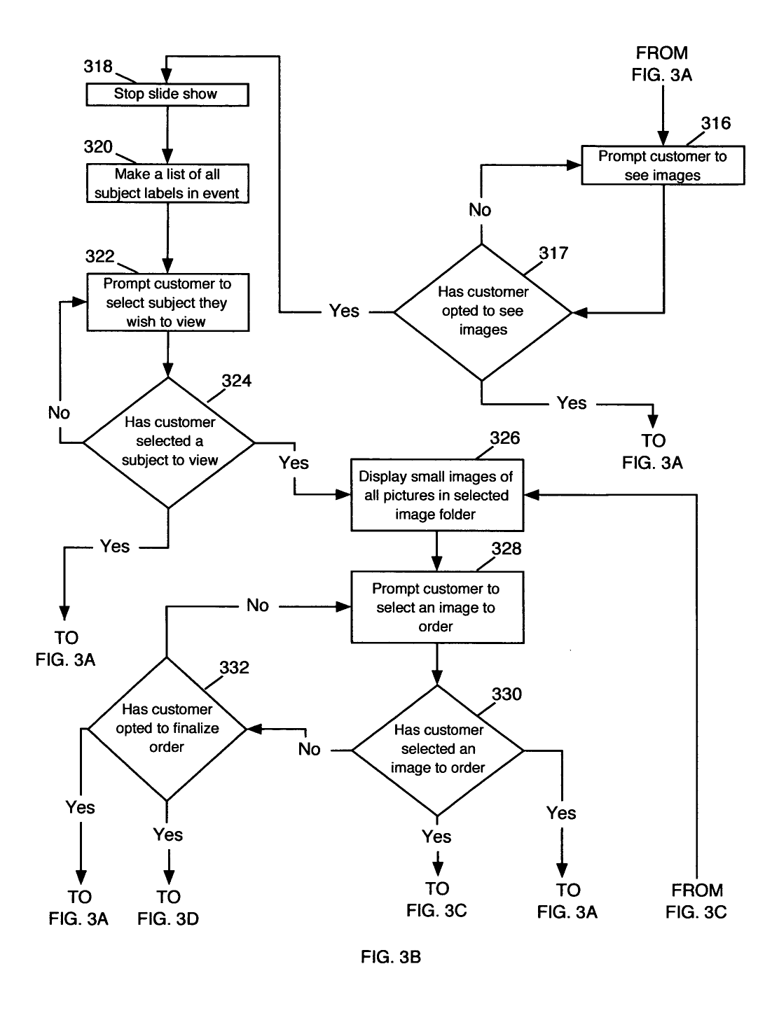

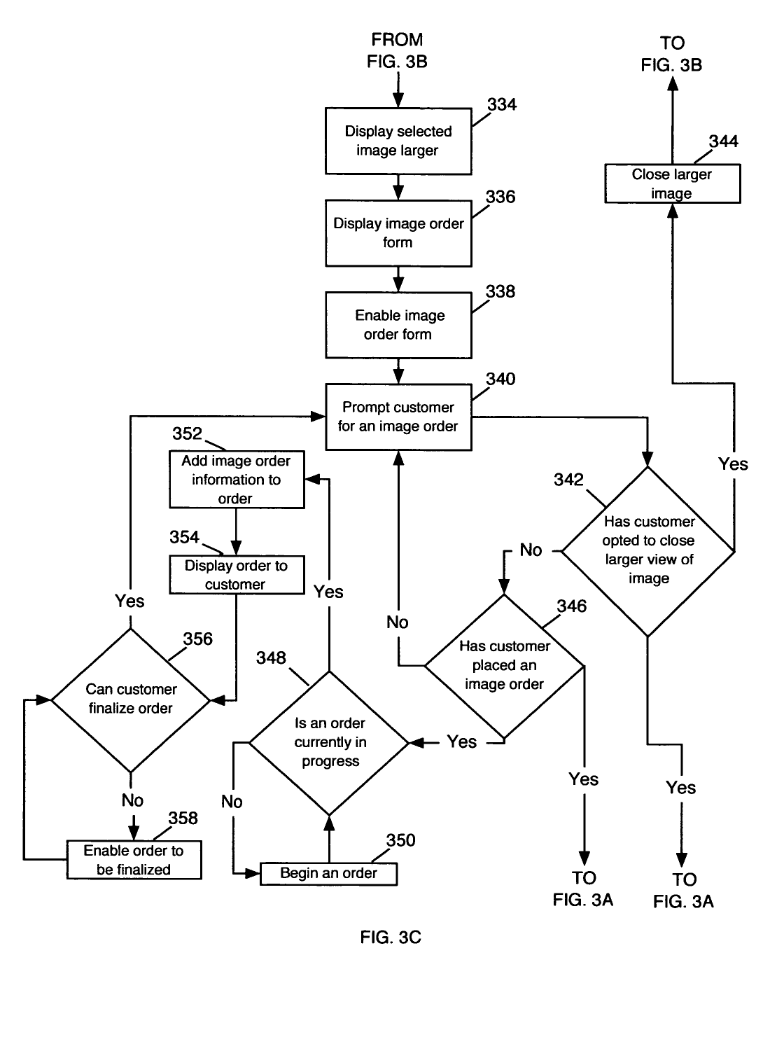

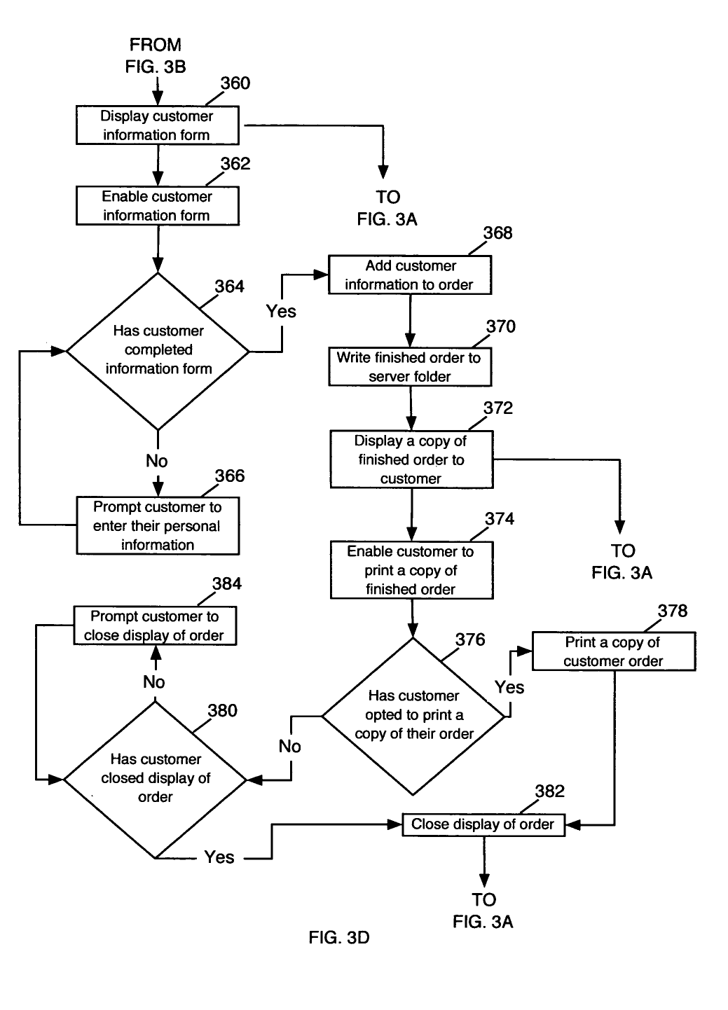

As will be described in greater detail when referring to FIGS. 2A-2C of the drawings, the location controls 3 prompts the photographer for the labels that are used to separate and locate different sets of the photographic images into respective image folders 10. In the present example, the information will correspond with the particular sound files (i.e., indicative of the names or player numbers of the children) which will be recorded by the photographer. The location controls 3 will also prompt the photographer for information (e.g., the children's team name) to complete the subtopic folders 12. As will also be described in greater detail when referring to FIG. 3A-3D, an image display 20 establishes click-on buttons corresponding to information contained within the image folders 10, the subtopic folders 12 and the topic folders 14 by which to enable a customer to quickly locate and view the low resolution (LR) images of his or her child that were taken by the photographer and are now available at the server folder 18. The header folder 16 will not be a click-on button but will be displayed as a heading which, in the present example, is determined by date to distinguish the images taken at different times.

Once the customer has located the photographic images of interest, a timer controlled image display 20 is initiated by which customers of the photographer view and order selected images that are available at the server folder 18 of the photographer's computer or a home computer. As will be described in greater hereinafter when referring to FIGS. 3A-3D of the drawings, the image display 20 plays a looping slide show of selected images and encourages customers to place an order. The customer may enlarge a selected image for clarity and then order prints of the image by quantity and size. In this case, an order form will be displayed which can be completed and finalized by adding the customer's personal information. The order information entered by the customer will be processed by an order viewer 26. The timer will eventually expire and the image display 20 will be automatically reset to accommodate a new customer.

In the alternative, a customer can use a web browser via a common gateway interface (CGI) 22 to view and order images over the Internet. In this case, the customer will send a request from his home computer by way of a web page link or an existing URL via a web browser. The customer can use the click-on buttons that are initiated by the common gateway interface to view and order images.

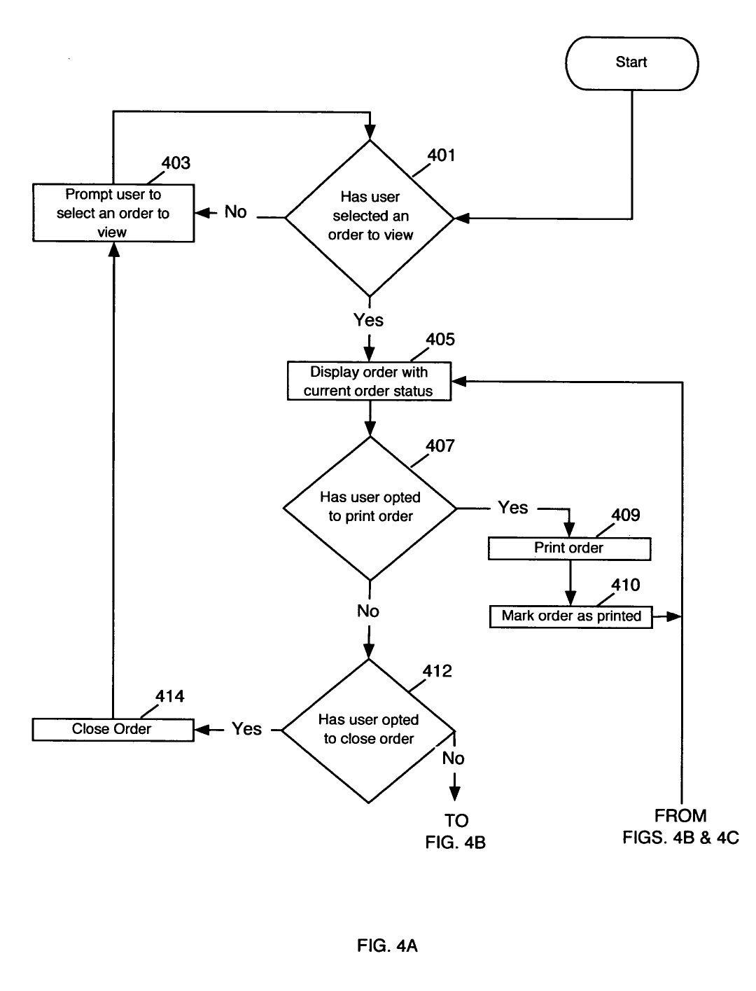

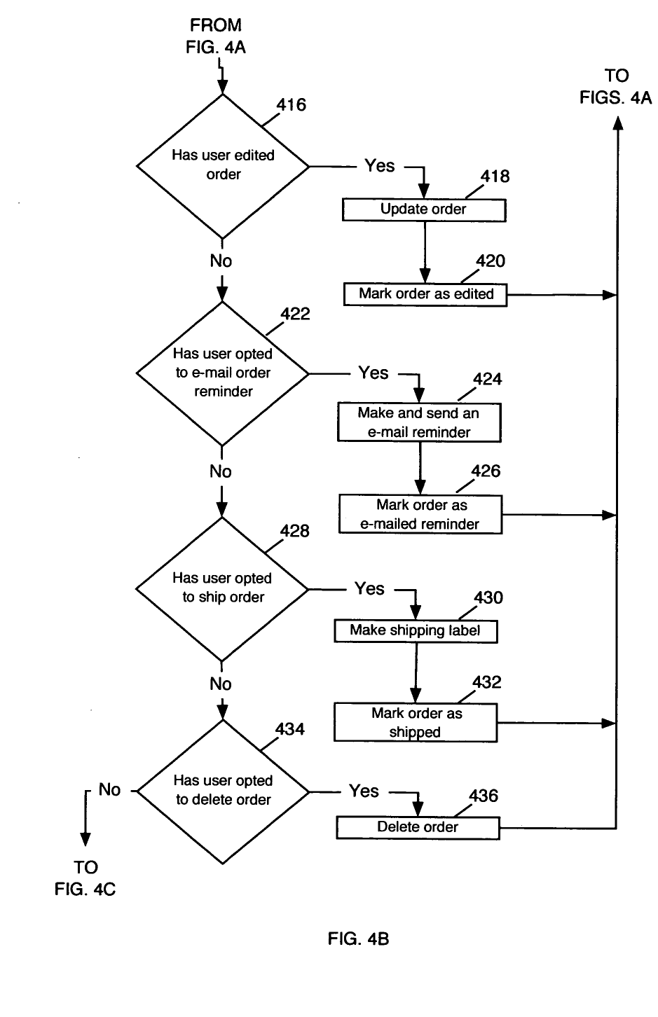

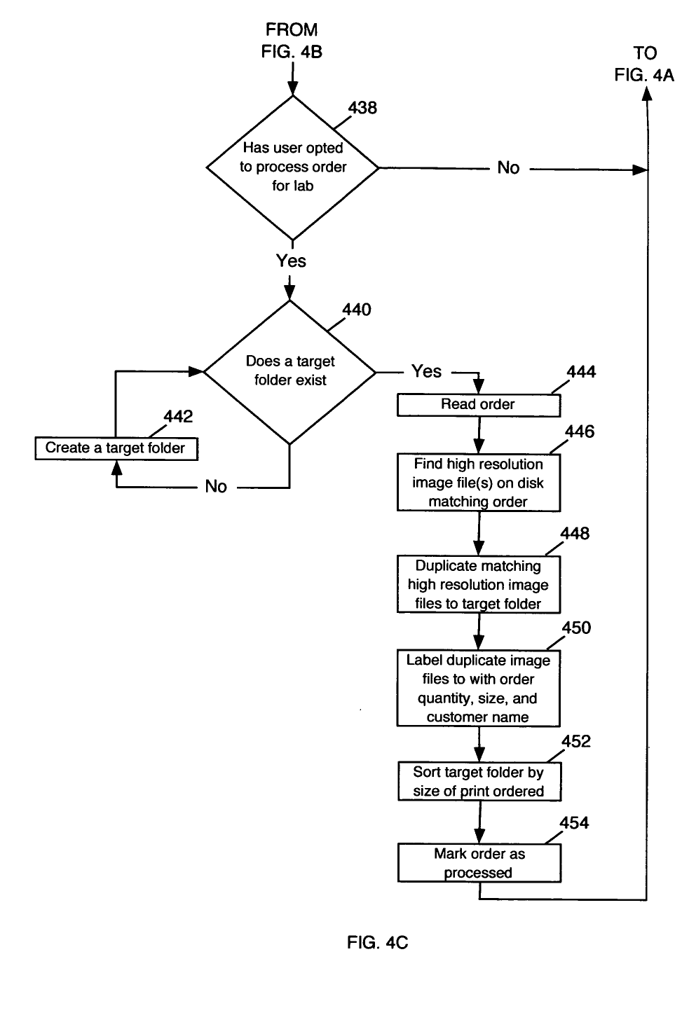

An order is received from either a remote computer or a home computer at an orders folder 24. The orders folder may be located within the server folder 18. As will be explained in greater detail hereinafter when referring to FIGS. 4A-4C of the drawings, the photographer initiates an order viewer 26 to view and process the orders of his or her customers. Briefly, the order viewer 26 displays a readable page by accessing data that is supplied from the image display 20 and the web CGI 22.

Although the low resolution (LR) images 7 from the image folders 10 are displayed for the customer, the customer's order is completed by using the high resolution (HR) images 5 that have been located in the high resolution storage folder 9. Depending upon the order and whether payment has been received, the photographer is provided with the ability to print a copy 28 of the customer's order, to send an e-mail payment reminder 30, and to send the order to a photo lab 32 in a target folder of the high resolution storage folder 9 for processing. The order viewer 26 also allows the photographer to open a folder 34 to track the status of the customer's order. Moreover, the photographer is provided with the ability to use the customer's information to make shipping labels 36 by which completed orders are mailed to the customer. Finally, the photographer may open a folder 38 in which his completed orders are recorded for archival purposes and reference in the future.

Turning now to FIGS. 2A-2C of the drawings, there is shown a flow diagram to illustrate the technique initiated by the location controls 3 of FIG. for efficiently organizing the photographic images taken by the photographer for viewing and purchase by customers via a remote (e.g., the photographer's) computer or on-line using the customer's home computer. As indicated above when referring to FIG. 1, and in the present example, the photographic images will be annotated and marked by sound marker files that are created from spoken words of the photographer in order to separate one set of images from the next according to subject.

The first step 101 of the photographic image organization technique initiated by the location controls 3 is to determine whether the high resolution storage folders and the low resolution subtopic folders (designated 9 and 12 in FIG. 1) have been created by the photographer. If they have not yet been created, then the photographer is prompted during step 103 to create folders 9 and 12. If the high and low resolution folders have been created, then a temporary working folder is created during step 104 in the high resolution storage folder 9 of FIG. 1. Next, a determination is made during step 105 as to whether the photographer has selected a type of marker (i.e., sound, locked image or flat image) to annotate the images. If no marker has been selected, then the photographer is prompted during step 107 to select a suitable marker. In this case, it is assumed that the photographer has already selected sound as the marker. Once a suitable marker has been selected, an inquiry is made during the next step 109 to determine whether the photographer has indicated the download of the sound and image data from the mass media storage device of his camera to his or her computer. If no download has been initiated, the photographer is prompted to start a download during step 110.

Provided that a download has been requested by the photographer, an inquiry is made during step 112 whether the mass media storage device of the digital camera in which the image and sound data is stored is accessible to the photographer's computer, such as by means of a portable card reader, or the like. If the mass media storage device is not positioned to communicate with the computer, then the photographer is prompted during step 114 to insert the storage device into the card reader. Once the storage device is properly mounted in its reader, a determination is made during step 116 whether there are any files presently stored to be downloaded from the storage device to the computer. If no file is detected to be downloaded from the storage device, then the photographic image organization continues at FIG. 2B.

In the event that there is at least one file to be downloaded from the storage device to the computer, then a determination is made during step 118 whether such file already exists in the high resolution storage folder 9. In the event that the file already exists, such file is redundant and is therefore skipped during step 120. However, if the file is new and not nearly redundant, then the name that has been assigned to the new file is added during step 122 to the list of earlier files (if any) to be downloaded. Next, at step 124, a determination is made whether there are any more files remaining to download. In the case where there are no other files to be downloaded to the computer from the storage device, the photographic image organization technique implemented by the location controls 3 continues at FIG. 2B. However, if there is at least one additional file to download from the storage device, it is once again determined if the new file already exists in the high resolution folder (at prior step 118) and can be skipped as a duplicate (at prior step 120) or can have its file name added to the existing list of files (at prior step 122).

After the complete list of files to be downloaded has been identified, the photographic image organization technique continues at FIG. 2B, where the identify of the marker file is determined (i.e., a sound file or a locked image file or a flat file). As indicated above, and for the purpose of this example, it is assumed that a sound file is created by the photographer for annotation purposes.

An initial inquiry is made during step 126 of FIG. 2B whether the marker file is a flat image file. Had a flat image marker file been used, then the photographer is prompted for a list of labels during step 127 and the files would then be downloaded during step 128 to the temporary working folder of the high resolution storage folder 9 that was created at prior step 104 of FIG. 2A. Because the marker file is not a flat image file, the files to be downloaded are checked for marker file type during step 130. Should it be determined during step 132 that there are more files to check, then a new inquiry is made during subsequent step 134 whether the marker file type is a sound file. It will be determined in step 135 that the marker file chosen by the photographer in this example is a sound file. Therefore, the particular sounds that are spoken by the photographer to annotate sets of photographs are played during step 136 and the photographer is prompted to enter corresponding labels. During step 138, each newly added label is added to a list of previous labels (if any) and, during step 140, the sound file is deleted.

Another investigation is made (at prior step 132) to determine if there are any more files to check. In the event that the aforementioned sound file was the last file to check, then all of the files are now downloaded to the aforementioned temporary working folder that was created during prior step 104. At this point, the mass media storage device is ejected during step 142 to be erased and returned to the photographer's camera for reuse.

Had the marker file type to be checked (at prior step 134) not been a sound file, then another inquiry would be made during step 144 to determine if the file were a locked file. If the file is determined to be neither a flat image type (at prior step 126), a sound file (at step 134) nor a locked file (at prior step 144), then the file is simply skipped during step 146, and the photographer is returned to the prior step 132 and to the inquiry whether there are more files to check. If, however, it was determined during step 144 that the checked file is a locked file, then the photographer would be prompted for a corresponding label during step 148 and the newly added label is then added to the list of previous labels during step 150. Provided it is found that there are now no more files to be checked (at prior step 132), then all of the files are downloaded to the temporary folding folder that was created during prior step 104, and the mass media storage device is ejected (at prior step 142) to be erased and reused.

Once the files have been downloaded into the temporary working folder of the high resolution storage folder 9 of FIG. 1, each file is checked during step 152 for its marker type. An inquiry is made during the following step 154 whether there are any more files to check in the temporary working folder. If there are no files remaining to check, then the photographic image organization technique continues at FIG. 2C. If there are additional files to check, an inquiry is made at step 156 whether the next file is a marker file type. If the next file to be checked is not a marker file, then an inquiry is made during step 158 whether there is a current list of image names. If there is no current list of image names, a new list is started during step 160 and the new image name is added to the list during step 162. If there already is a list of image names, then any new name is added to the existing list at prior step 162 and the photographer is returned to step 154.

If a marker file is detected as the next file to be checked during the following step 156, then an image folder is made during step 164 within the temporary folder of the high resolution storage folder 9. The image folder is created with a corresponding label from the list of labels that was assembled during the prior steps 127, 138 or 150. During step 166, the image files which match image names already in the list of names are transferred to the image folders 10 of FIG. 1. During the next step 168, the image folders are duplicated and transferred to the high resolution (HR) folder 5 of FIG. 1. Accordingly, the high resolution (HR) and the low resolution (LR) folders 5 and 7 as well as the image folders 10 of FIG. 1 will now be created. After the HR and LR folders 5 and 7 are created, the current list of image names from prior step 162 is erased during step 170, and the photographic image organization technique is returned to prior step 154 and to the original inquiry whether there are any more temporary files to be checked.

As indicated above, if there are no more files in the temporary folder to check at prior step 154, the photographic image organization technique continues at step 172 of FIG. 2C where the photographer is asked if he or she has chosen to rotate the images (e.g., to orient the images from the vertical to the horizontal). If desired, the images are rotated during step 174 in the temporary folder of the high resolution storage folder 9. Whether or not there are rotated during prior step 174, the images are resized or shrunk in the temporary folder during step 176 (i.e., the resolution is decreased from a high resolution size of about 2000×3000 pixels to a low resolution size of about 200×300 pixels). At step 178, the file names located in the high resolution folder 9 are recorded for the purpose of optional editing. Finally, during step 180, all of the large and small sized images are transferred to the low resolution (LR) folder 7 of FIG. 1. The image and subtopic folders 10 and 12 will now be created to be merged and transferred to the server folder 18 so as to enable customers to view, select and order images at which time the image controls 3 returns to prior step 114 of FIG. 2A.

Referring to FIGS. 3A-3D of the drawings, there is shown the steps initiated by the image display 20 of FIG. 1 by which customers of the photographer may view and purchase the photographic images that have been taken by the photographer and displayed on a remote computer, such as that belonging to the photographer. During the initial step 301 of FIG. 3A, an inquiry is made whether the photographer has selected the subtopic and server folders (designated 12 and 18 in FIG. 1). If these folders have not been selected, the photographer is promoted to select the event and server folders during step 303.

Once the subtopic and server folders 12 and 18 of FIG. 1 have been selected, the photographer is asked during step 305 if he or she has set his prices should customers wish to purchase any of the images taken by the photographer. If prices have not been set, the photographer is prompted during step 307 to select his pricing information. If the pricing information has been selected, customer parameters corresponding to the name, address, credit card information, etc. are reset during step 309 so as to accept the information for a new customer. Next, during step 310, a slide show is created from those images in the image folder 10 of FIG. 1, and the slide show is displayed to the customer during step 312. In the event that the slide show is not running, another attempt is made during step 314 to create and show the slide show (steps 310 and 312).

With the slide show running, the image display method continues at FIG. 3B, where the customer is prompted during step 316 to view the images. If the customer elects to view the images during step 317, a timer function (shown in FIG. 3A) is initiated by means of a count down timer and the slide show is terminated during step 318. Then, during step 320, all of the labels that are stored in the subtopic folder (designated 12 in FIG. 1) are listed for the customer. During step 322, the customer is prompted to select one of the subjects to view on the (e.g., photographer's) computer. If the customer has not selected a subject during step 324, he or she is once again prompted to make a selection at prior step 322.

In the event that the customer has selected a subject to view, then the timer function of FIG. 3A is initiated and a series of relatively small images from the image folder 10 of FIG. 1 are displayed for the customer during step 326. Following the small image display, the customer is prompted during step 328 to choose one of the images to order. If the customer has selected an image during step 330, then the timer function of FIG. 3A is again initiated and the image display 20 of FIG. 1 continues at FIG. 3C. However, should the customer decide during step 330 not to order an image, then an inquiry is made during step 332 whether the customer is not interested in additional images and is ready to finalize his or her existing order. If the customer is not ready to finalize the order, then he or she is given another opportunity (at prior step 328) to select an image to order. However, if the customer has decided to finalize the order, then the timer function of FIG. 3A is again initiated and the image order process continues at FIG. 3D.

Returning to FIG. 3A, the aforementioned timer function to which reference was made in FIG. 3B is now described. A timer function is provided by means of a count down timer to allow the customer a predetermined time to make a decision and to click a particular button corresponding to that decision. If the customer's decision is unnecessarily delayed or should the customer simply walk away from the computer, then the count down timer will time out and the image display process will be automatically reset for a new customer or the same customer to start over. More particularly, the timer function is initiated by resetting the count down timer during step 334 and then allowing the timer to start and continue to count for a predetermined time during steps 336 and 337.

In the case of step 338 where the count down timer has counted out and expired, the customer is warned during step 340 that the image display process will be terminated and reset for a new customer. In order to allow the customer more time to make a decision, he or she is given the opportunity during step 342 to cancel the impending reset of the image display process. If a customer elects to cancel the reset during step 344, the count down timer is once again reset. If a customer elects not to cancel the reset during step 344, then all customer parameters are once again reset (at prior step 309) to await the participation of a new customer wishing to view the images for possible purchase.

If the customer has decided to select an image to order during step 330, then the selected image is increased in size during step 334 of FIG. 3C. During step 336, an order form is displayed and, during the next step 338, corresponding click-on buttons are enabled so that the customer can order the image of his or her choice in terms of size, price, quantity, etc. The customer is then prompted during step 340 to actually enter his or her order for the selected image.

The customer is first given an opportunity during step 342 to close the relatively large image that was previously selected and displayed (at step 334). If the customer so elects, the larger image is closed during step 344 and the customer is again shown the smaller images that were previously during step 326 of FIG. 3B so that he or she will have a chance to choose a different image. At the same time, the count down timer is reset as described at prior step 334 of FIG. 3A to limit the decision time of the customer to select and order the image of choice.

If the customer has otherwise chosen not to close the relatively large image during step 342, an inquiry is made during step 346 to determine if the customer has placed an image order. When no image order has been placed, the customer is once again prompted (at prior step 340) for an image order. However, when an image order is placed, an inquiry is made during step 348 whether the ordering process is in progress. At the same time, the count down timer is reset as described at step 334 of FIG. 3A to limit the time during which the customer can complete the order. If no order has already been created, then a new order is created during step 350 and the results of that order are stored for processing by the photographer.

Provided that the customer's order is in progress and the count down timer (of FIG. 3A) has not yet timed out, the image order information previously entered during step 346 (e.g., size, price, quantity, etc.) is now added to the customer's order during step 352. During step 354, the order is displayed to the customer for his or her review. If the customer is now able to finalize the order for the chosen image during step 356, then he or she is given another opportunity (at prior step 340) to place an additional image order. If the customer's order cannot be finalized, then the customer is enabled during step 358 to now finalize the order.

As earlier described when referring to step 332 of FIG. 3B, in the event that the customer has chosen to conclude the order, then a customer information form is displayed during step 360 of FIG. 3D. At the same time, the count down timer at step 334 of FIG. 3A is reset to limit the time during which the customer can finalize the order. The customer now enters appropriate personal information (e.g., name, address, form of payment, etc.) onto the customer information form during step 362 and an inquiry is then made during step 364 whether the customer information form has been completed. If the form has not been completed, the customer is prompted during step 366 to enter the missing information.

If the customer information form has been completed, then the personal information entered by the customer is added to the customer's order during step 368. During step 370, the completed order is sent to the server folder (designated 18 in FIG. 1), and a copy of the final order is displayed to the customer during step 372. At the same time, the count down timer at step 334 of FIG. 3A is reset to limit the time for the customer to review his or her order. The customer may then wish to receive a printed copy of his or her order during step 374. If requested during step 376, then a print out of the finished order is provided to the customer during step 378. However, if the customer does not require a printout of the order and wishes at step 380 to close the display of his or her order, then the former display of the order is closed during step 382. If the customer does not wish a printed copy of the order and has not closed the display, the customer is promoted at step 384 to close the display. In the event that the customer has requested a printed copy of the order during step 378, then the former display of the order is automatically closed at step 382, and the count down timer of FIG. 3A is reset. In time, the count down timer will time out because the order process has now been completed. Accordingly, and as originally described when referring to step 309 at FIG. 3A, all of the customer parameters will be reset to await the participation of a new customer and a new order using the image display 20.

As was earlier described, orders are received from customers of the photographer at the orders folder 24 of FIG. 1 that is located on the server folder 18 for inspection. As also described, orders from customers are transmitted from a remote computer by means of the image display 20 or on-line from a customer's home computer by means of a web browser via common gateway interface (CGI) 22. Referring now to FIGS. 4A-4C of the drawings, details are provided of the order viewer 26 of FIG. 1 and the manner in which the photographer views and processes the orders of his or her customers and monitors the status of such orders that have been forwarded to orders folder 24.

The order processing and monitoring begins at initial step 401 where a photographer is asked if a particular customer order has been selected for review. Orders may be called up for viewing by means of a name or number that is assigned by the image display 20 of FIG. 1. If no order has been selected for review, the photographer is promoted during step 403 to select an order. If an order has been selected, it is displayed during step 405 with an indication of its status (e.g., the order is at the photo lab 32, a print out 28 of the order has been provided, a payment reminder 30 has been e-mailed to the customer, etc.). The photographer is asked during 407 if he or she would like a hard copy of the order. If a copy is requested by the photographer, the order is printed during step 409 and marked during step 410 to indicate that a print-out thereof has been made. However, if a print-out of the order is not necessary, or if the original order has been filled and sent to a customer, the photographer can decide to close the order during step 412, whereby the original order will be closed during step 414 to complete its visual inspection. The photographer is once again prompted (at prior step 403) to now select a new order for review.

In the case where the photographer has decided (during prior step 412) not to close the order, the order viewing and processing continues at step 416 of FIG. 4B where an inquiry is made whether the photographer has edited the order. It may be that the original order must be changed because the customer has modified his or her original order information. Should the order be in need of change, then updates are made during step 418, and the order is marked during step 420 as being edited. The photographer is then returned to step 405 of FIG. 4A where the updated order is now displayed for further review.

If it is not necessary to edit the original order, then another inquiry is made during the next step 422 whether the photographer has e-mailed an order reminder to the customer. It may be that the customer has not yet paid or made arrangements to pay for the order. Should a payment reminder be necessary, then an e-mail notice is made and sent during step 424, and the order is marked during step 426 to denote that a reminder has been sent. The photographer is then returned to step 405 of FIG. 4A where the updated order is displayed for further review.

In the case where the photographer has decided (during prior step 422) not to send a billing reminder, the order viewing and processing continues at step 428 of FIG. 4B where an inquiry is made whether the photographer wishes to create a shipping label so as to mail a completed order to the customer. If payment has been made, the photographer creates a shipping label and ships the order during step 430, and the order is marked during step 432 to indicate shipment to the customer. The photographer is then returned to step 405 of FIG. 4A where the updated order is displayed for further review.

In the case where the photographer has decided (during prior step 428) not to ship the order, the order viewing and processing continues at step 434 of FIG. 4 where an inquiry is made whether the photographer wishes to cancel the order. If payment has not been received from the customer after first sending a reminder (during prior step 424), then the photographer may choose during step 436 to delete the order in its entirety. In the case where an updated order that is reviewed by the photographer is not to be shipped or deleted, then the order viewing and processing continues at step 438 of FIG. 4C where an inquiry is made whether the photographer wishes to make an order ready for processing at the photo lab 32 of FIG. 1. If lab processing is not necessary (e.g., because the order has already been completed during prior step 432), the photographer is returned to step 405 of FIG. 4A where the order can eventually be closed (at prior step 414).

However, if lab processing is desired, then an inquiry is made during step 440 whether a target folder was created in the high resolution storage folder 9 of FIG. 1. If the target folder has not yet been created, then a target folder is created during step 442. In the event that a target folder already exists, then the customer's order is read at step 444. During step 446, the stored high resolution image file or files matching the customer's order are located at the high resolution storage folder 9. So as not to effect the original files, the stored high resolution files are duplicated during step 448 and added to the target folder. The duplicated image files are labeled during step 450 with appropriate order information (e.g., indicative of quantity, size, customer name etc.), and the target folder is sorted by print size during step 450. As illustrated in FIG. 1, the target folder is now ready to be sent to the lab 32, and the original order is now marked during step 454 as being processed. The photographer is then returned to step 405 of FIG. 4A where the updated order is now displayed for further review and closure in the manner described above.

1. A method by which photographic images taken by and stored in a digital camera are downloaded to a computer at which the photographic images are located for viewing, said method comprising the steps of:
annotating said photographic images by assigning markers to identify different sets of said images according to subject;
downloading said images from the digital camera to the computer;
assigning labels to each of the different sets of images corresponding with the markers assigned thereto;
locating said set of images in respective image folders according to said labels; and
accessing and viewing a particular set of images located in a particular one of said image folders.

2. The method recited in claim 1, wherein said digital camera includes a mass media storage device adapted to store sound data and the photographic images taken by the camera to be downloaded to the computer, said method comprising the additional step of annotating said photographic images by means of sound markers spoken into and stored by the mass media storage device.

3. The method recited in claim 1, wherein the digital camera includes a mass media storage device adapted to store the photographic images taken by the camera to be downloaded to the computer, said method comprising the additional step of annotating said photographic images by means of flat image markers shot by the camera and stored by the mass media storage device.

4. The method recited in claim 1, wherein the digital camera includes a mass media storage device adapted to store the photographic images taken by the camera, said method comprising the additional step of annotating said photographic images by means of locked image markers stored by the mass media storage device.

5. The method recited in claim 1, including the additional step of locating information in at least one additional group of folders corresponding to events or topics associated with the different sets of said photographic images, and accessing and viewing the particular set of image located in a particular one of said image folders depending upon the information located within a particular folder of said additional group of folders.

6. The method recited in claim 5, including the additional steps of merging said image folders into said additional group of folders, transferring said merged folders to a computer server folder, and accessing and viewing the particular set of said images at said server folder.

7. The method recited in claim 6, including the additional step of copying the photographic images taken by the camera to create high resolution and low resolution images, downloading the low resolution images to the computer to create said image folders, and accessing and viewing a particular set of said low resolution images located in a particular one of said image folders.

8. The method recited in claim 7, including the additional step of storing said high resolution photographic images in a high resolution storage and transmitting said high resolution images from said storage to a photo lab for processing.

9. The method recited in claim 1, including the additional step of displaying the particular set of images being accessed and viewed as a slide show.

10. The method recited in claim 9, including the additional step of displaying an offer to enable one or more of the images from the particular set of images at said slide show to be acquired.

11. The method recited in claim 10, including the additional step of displaying an order form to be completed by which to enable one or more of the images from the particular set of images at said slide show to be acquired.

12. The method recited in claim 11, including the additional step of initiating a timer by which to limit the time available during which to complete said order form.

13. The method recited in claim 11, including the additional steps of viewing and editing the order form, and marking the order form as being edited.

14. The method recited in claim 11, including the additional steps of e-mailing a reminder concerning the order form, and marking the order form to indicate an e-mail reminder.

15. The method recited in claim 14, including the additional steps of making a shipping label from information listed in the order form and using the shipping label to mail the order.

16. A method by which photographic images taken by and stored in a digital camera are downloaded to a computer at which the photographic images are located for viewing, said method comprising the steps of:
annotating said photographic images by assigning markers to identify different sets of said images according to a subject associated with the photographic images taken by the camera;
copying the photographic images taken by the camera into high resolution images and low resolution images;
transferring said high resolution images to a high resolution storage folder for processing;
creating subtopic folders in the computer corresponding to events associated with the photographic images taken by the camera;
downloading said low resolution images to image folders of the computer;
assigning labels to each of the different sets of low resolution images corresponding to the markers assigned thereto and locating the different sets of low resolution images in respective image folders according to said labels;
merging said image folders with said subtopic folders and transferring said image and subtopic folders to a computer server folder;
accessing, viewing and placing an order for a particular set of low resolution images in a particular one of the image folders located at said computer server folder; and
filling the order for the set of low resolution images from the high resolution images at said high resolution storage folder.

17. The method recited in claim 16, wherein said digital camera includes a mass media storage device adapted to store sound data and the photographic images taken by the camera, said method comprising the additional step of annotating said photographic images by means of sound markers spoken into and stored in the mass media storage device.

18. The method recited in claim 16, wherein said digital camera includes a mass media storage device adapted to store the photographic images taken by the camera, said method comprising the additional step of annotating the photographic images by means of flat image markers shot by the camera and stored by the mass media storage device.

19. The method recited in claim 16, wherein said digital camera includes a mass media storage device adapted to store the photographic images taken by the camera, said method comprising the additional step of annotating said photographic images by means of locked image markers stored by the mass media storage device.

20. The method recited in claim 16, including the additional steps of displaying an order form by which to enable said order to be placed for the particular set of low resolution images in the particular one of the image folders, and initiating a timer by which to limit the time available during which to complete the order form.
